(19) United States
(12) Patent Application Publication
(10) Pub. No.: US 2003/0043192 A1
(43) Pub. Date: Mar. 6, 2003

(54) Dynamically modifiable user interface

(75) Inventor: Cedric K. R. H. Bouleau, Leander, TX (US)

Correspondence Address: Schlumberger Technology Corporation, 8311 North FM 620, Austin, TX, 78726, US

(73) Assignee: Schlumberger Technology Corporation

(21) Appl. No.: 09/943,939

(22) Filed: Aug. 31, 2001

(51) Int. Cl. G09G 5/00

(52) U.S. Cl. 345/762

(57) ABSTRACT

The present invention provides a user interface that may be dynamically modified by a user. The user interface is generated from a UI view definition that defines panels and controls to be included as part of the user interface. The user may modify the UI view definition and a UI view manager dynamically generates the user interface. Controls are wrapped to include a communication interface to dynamically communicate with the UI view manager.

Portions of this patent application contain materials that are subject to copyright protection. The copyright owner has no objection to the facsimile reproduction by anyone of the patent document, or the patent disclosure, as it appears in the Patent and Trademark Office file or records, but otherwise reserves all copyright rights whatsoever.

### BACKGROUND OF THE INVENTION

1. Field of the Invention

The present invention relates to user interfaces and particularly to user interfaces that may be dynamically modified by a user.

2. Description of the Related Art

In a large enterprise, typically no single software application exists that meets the needs of all users for all types of enterprise data. Different software applications exist for providing different types of functionality and/or for using different types of enterprise data. Each of these software applications may provide a user interface to allow users to view and access enterprise data and/or to use other tools to help the user perform his or her job.

A console is a software application program that provides a user interface for a user to perform a job such as controlling or monitoring equipment. Different consoles are typically provided to perform different types of jobs and/or for different types of equipment. An example of a console is a software application used by an oil well field engineer to control and monitor oil welling drilling equipment.

A console may provide a number of controls to assist the field engineer. A control provides functionality for the user to perform a particular task and/or provides data that the user can use to perform his or her job. Different controls can, for example, visually display the drilling site, provide data regarding the drilling job, enable the user to control equipment, and so on.

Many consoles are designed such that the console itself does not implement the control and monitoring features. Rather, the console acts as a manager of various other software components that operate as a cohesive unit. Such a console's responsibilities are to handle the layout of the various components as a user interface and manage the operation of the various controls. The console may incorporate functionality of various controls, including controls that are developed by third parties, without duplicating code or functionality available elsewhere. The controls themselves typically do not operate as stand-alone application programs, but rather, controls are run within a container application such as a console container.

Software consoles are typically built to provide a fixed user interface, with only minor functionality customizable by the user, such as options on a toolbar. The software engineer starts designing and implementing the console, knowing how many controls will be required and where and when they will be used. These controls are then embedded inside the console application and the console is shipped out to the field. The addition of new functionality to the console requires changes in the console application, and these changes may typically be made only by a software engineer. Thus a console application that is widely distributed across an enterprise may be cumbersome to change and modify, and major functional components must be added, tested and distributed as a centralized, coordinated operation.

Moreover, consoles typically include programming code to communicate only with the particular controls embedded within. Delegating the responsibility for communication to the console increases the complexity of the console application and results in a loss of flexibility because incorporating new controls requires changes to the console application.

Furthermore, to incorporate some controls, a license for the native development environment of the control is needed. For example, to incorporate a control developed in a Visual Basic development environment into a user interface, both a development license and a run-time license must be obtained. If more than one developer is working on a console, which is typically the case in a large enterprise, then each developer needs a development license for the each control that the console embeds. In an environment with many software developers, these licensing requirements may be very costly.

What is needed is a user interface that allows functionality in the form of components to be added and managed dynamically. These components should include controls that may provide a user interface and/or functionality. The console should be implemented as a basic console for the different parts of a system and allow users such as field engineers to extend or modify the components of the console to better suit the way they do their jobs. A basic console should be able to be created and modified quickly and easily. Preferably, the basic console should be modifiable without the need for each user making a modification to have a development license.

### SUMMARY OF THE INVENTION

The present invention provides a user interface that may be dynamically modified by a user. The user interface is generated from a user interface view definition that defines panels and controls to be included as part of the user interface. The user may modify the UI view definition and a UI view manager dynamically generates the user interface. Controls are wrapped to include a communication interface to dynamically communicate with the UI view manager.

In one feature of the invention, an apparatus includes a UI view definition for a user interface and a UI view manager to dynamically generate the user interface from the UI view definition. A wrapper is used by the UI view manager to provide a wrapped control as part of the user interface. The wrapper may include a control interface to communicate with the wrapped control and a UI view interface to communicate with the UI view manager. The UI view manager dynamically generates the user interface in response to a change to the UI view definition.

The apparatus may include a user interface designer for providing a UI view definition. Further, the UI view definition may include a control definition for a control of the user interface, where the control definition defines a user interface element of the control and a program identifier of code to provide functionality of the control. The UI view definition may include a panel definition for a panel of the user interface. In one embodiment, the UI view definition may be implemented as an XML file.

In another feature of the invention, a method includes dynamically generating the user interface from a UI view definition. The generating includes using a wrapper for generating a wrapped control as part of the user interface.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 shows components of a dynamic user interface of the present invention.

FIG. 2 shows an example of the dynamic user interface of FIG. 1.

FIG. 3A shows elements of the control of FIG. 1.

FIG. 3B shows elements of a wrapped control.

FIG. 4 shows an example of components implementing the dynamic user interface, including the wrapped control of FIG. 3B.

FIG. 5 is an analysis model class diagram illustrating the key abstractions for the dynamic user interface.

FIG. 6 is an example of a UI view definition.

FIG. 7 is a sequence diagram showing an example of actions taken to initialize the dynamic user interface.

FIG. 8 is a sequence diagram showing an example of actions taken to start a container for the dynamic user interface and to initialize a panel, a control and a menu.

FIG. 9 is a sequence diagram showing adding a new panel to the dynamic user interface.

FIG. 10 is a sequence diagram showing adding a control to an existing panel.

FIG. 11 is a sequence diagram showing removing a control from a panel.

FIG. 12 is a sequence diagram showing saving a view.

FIG. 13 is a sequence diagram showing the UI view manager notifying the controls that UI access information has changed.

FIG. 14 is a sequence diagram showing one control creating another control.

FIG. 15 is a design class diagram for an example implementation of the dynamic user interface.

FIG. 16 presents a dual mode of operation of the UI view manager of FIG. 5.

FIG. 17 shows a block diagram of a computer system suitable for implementing the present invention.

The use of the same reference symbols in different drawings indicates similar or identical items.

### DETAILED DESCRIPTION

The following is intended to provide a detailed description of an example of the invention and should not be taken to be limiting of the invention itself. Rather, any number of variations may fall within the scope of the invention which is defined in the claims following the description.

The present invention provides a user interface that may be dynamically modified by a user. The term user as used herein includes both a human user of a computer as well as a software program and/or hardware that is configured to use the user interface. An example of a user interface that is an oil well drilling console is provided herein, although the invention is not so limited. The present invention is not limited to developing a particular type of user interface or to a specific type of software application but rather is useful for development of user interfaces in general.

The dynamic user interface is generated from a UI view definition that defines panels and controls as components of the user interface. A UI view manager dynamically generates the user interface from the UI view definition, so that user changes to the UI view definition are dynamically reflected in the user interface. Controls are wrapped to include a communication interface to dynamically communicate with the UI view manager.

The dynamic user interface allows dynamic creation of panels and controls by a user. Panels may include floating and dockable windows. Positioning and geometry of panels and controls are managed by a UI view manager. Panels may be defined to contain multiple controls.

Controls within the user interface may communicate with each other via an interface to the UI view manager. For example, a control may request the creation of another control. Communication between controls via the UI view manager enables the dynamic user interface to operate as an integrated whole.

The user interface includes a wrapper that implements a dynamic communication interface for communication between controls and the UI view manager. The UI view manager may send a message to a control and receive a message from a control. The UI view manager starts and terminates panels and controls when they are needed. In one embodiment, the user interface operates in conformance with MS-Windows application standards.

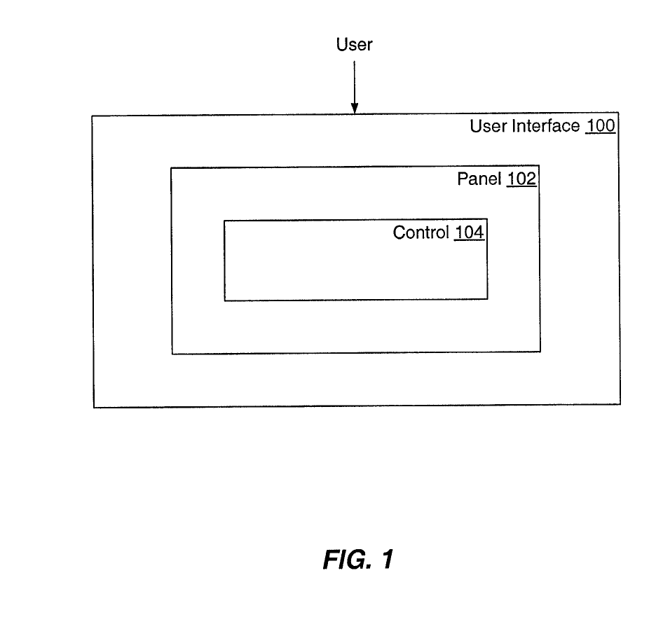

FIG. 1 shows components of dynamic user interface 100 of the present invention. Dynamic user interface 100 corresponds to a particular configuration of panels and controls serving as a user interface for a particular software application. The particular configuration of panels and controls is also referred to as a view or a UI view. One software application may have more than one view, each of which corresponds to a different user interface 100 for the particular software application. In one embodiment of the invention, a user may save one or more UI views for a particular software application to be selected from when the user is using that software application.

Dynamic user interface 100 may include one or more instances of panel 102. Panel 102 represents a generic panel or window that may be included as part of user interface 100 and is used to describe panels generally. The phrase “an instance of panel 102” refers to a particular panel in user interface 100 and each instance is referred to using a parenthetical indication of the instance, such as panel 102(1).

Examples of properties of a panel include the type of panel, whether the panel is editable, whether the panel may contain multiple controls or only one control, and whether the panel may be hidden or not.

An instance of panel 102 may be embodied as a standard Multiple Document Interface (MDI) child window that floats inside the child's parent window. Alternatively, an instance of panel 102 may be embodied as a window that may be docked to its parent. Such a dockable panel may also be undocked from its parent to float anywhere on the screen, including outside its parent window. When more than one instance of panel 102 is included in user interface 100, typically the different panel instances provide different functionality. This functionality is provided not by the panel instances themselves, but by controls within each instance of panel 102.

Control 104 represents a generic control that may be included in user interface 100. Control 104 may provide a visual display and/or functionality but is not required to include both. For example, a particular instance of control 104 may provide a visual display but no functionality for the user to interact with the visual display.

As examples of control instances, a first instance of control 104 may perform a series of calculations but not provide any sort of visual display. A second instance of control 104 may visually display the results of the calculations performed by the first instance of control 104 as part of the user interface 100 and provide functionality for the user to interact with the visual display. As another example, a third instance of control 104 may provide the functionality to access enterprise data and present the enterprise data in graphical form. Enterprise data may be stored in the form of a database and a control 104 may include the functionality necessary to connect to the database and retrieve the enterprise data to display or to perform functions.

An instance of control 104 may be implemented as part of a dynamic link library (.DLL file). Including code for an instance of control 104 in a dynamic link library enables the instance of control 104 to stand alone rather than to be embedded within code providing user interface 100.

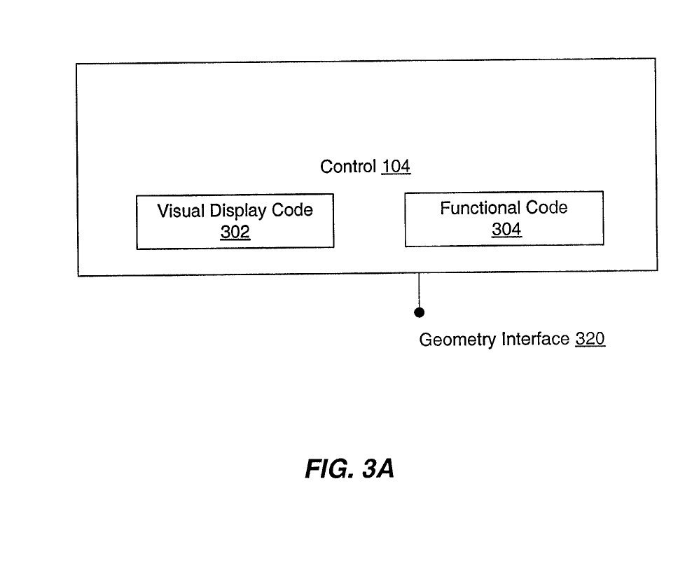

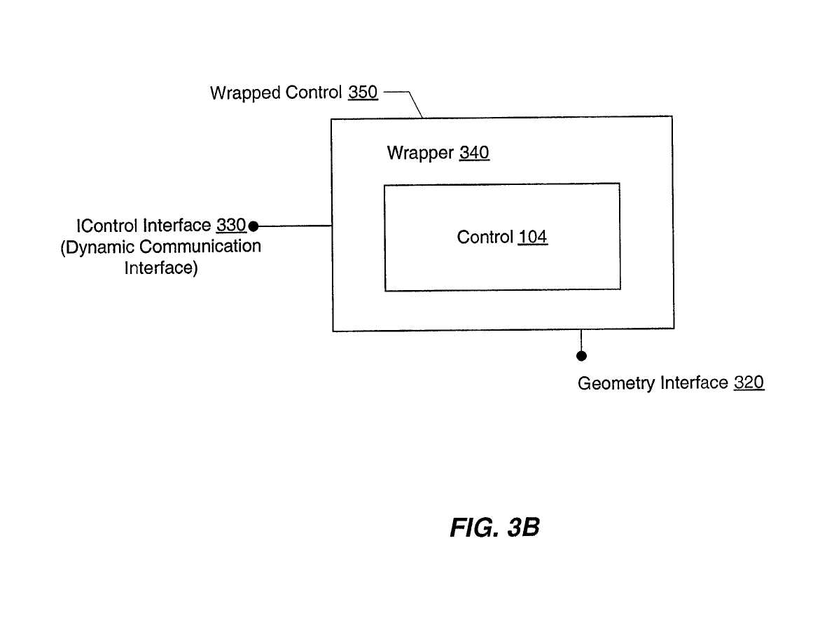

Two types of control 104 are described herein, a standard control and a wrapped control. The term control 104 is used herein to refer to both standard and wrapped controls. Standard and wrapped controls are described further below with reference to FIG. 3A and FIG. 3B.

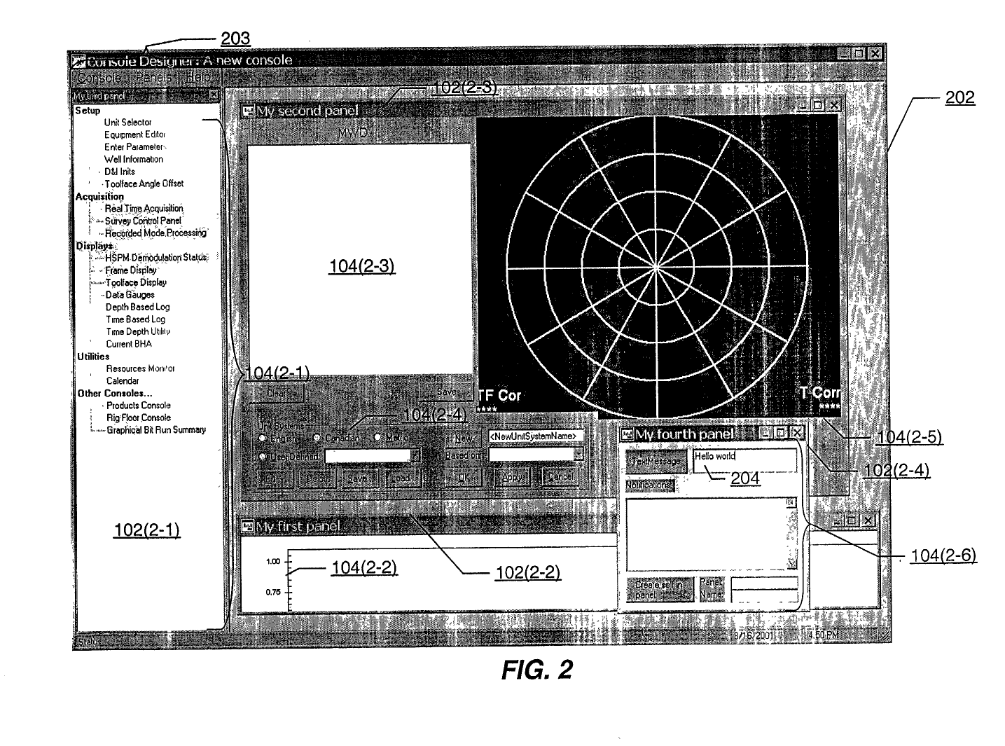

FIG. 2 is an example of the dynamic user interface 100. In the example shown, top-level window 202 includes a menu 203 and four instances of panel 102, labeled 102(2-1), 102(2-2), 102(2-3) and 102(2-4). Panel instance 102(2-1) is an example of a dockable panel that is anchored to the left side of the top-level window 202 displaying user interface 100.

A panel 102 may include one or more controls. Panel 102(2-1) includes an instance of control 104, control instance 104(2-1), that displays information in a tree structure. A single control 104 displays the entire tree structure. Panel instance 102(2-2) is another example of panel 102 that includes a single instance of control 104, control instance 104(2-2). Panel instance 102(2-3) is an example of a panel 102 that includes more than one instance of control 104, control instance 104(2-3), control instance 104(2-4) and control instance 104(2-5). Panel instance 102(2-4) is another example of panel 102 that includes a single instance of control 104, control instance 104(2-6). Control instance 104(2-6) includes text message button 205 that, when activated, displays a message such as message 204, here “Hello world.” Message 204 is displayed within an edit box included in the visual representation of control instance 102(2-6).

A panel instance such as one of panels 102(2-1), 102(2-2) and 102(2-4) with only one instance of control 104 may be presented with the control filling the entire panel. When the panel is resized, the control may also resized. Panel 102(2-1) is an example of a control filling the entire panel. Alternatively, an instance of panel 102 having a single instance of control 104 may be presented as a fixed size that cannot be resized. The size of a fixed size instance of panel 102 is fixed to the size of the instance of control 104 contained within.

FIG. 3A shows elements of control 104. Control 104 corresponds to a software component that may include code to produce a visual representation of the control, called visual display code 302. Control 104 may also include code providing functionality, called functional code 304. Functional code 304 may provide functionality that the user may use to interact with the visual representation of the control, such as a button to click or a scroll bar. Functional code 304 may also provide functionality, for example, to display data, wherein the user has no ability to interact with the visual representation. It is not required that every instance of control 104 include both visual display code 302 and functional code 304, although instances of control 104 preferably include at least functional code 304.

Geometry interface 320 may be implemented for an instance of control 104. Geometry interface 320 enables the visual representation of an instance of control 104 to be resized and moved as well as other manipulations to be performed to the geometry of the instance of control 104. Geometry interface 320 is typically provided as part of the native development environment which the instance of control 104 is developed. For example, an ActiveX control may be resized or moved by virtue of using standard ActiveX interfaces. No additional code is added to the ActiveX control to enable the visual representation of the ActiveX control to be resized or moved. It is not required that every instance of control 104 include an geometry interface 320.

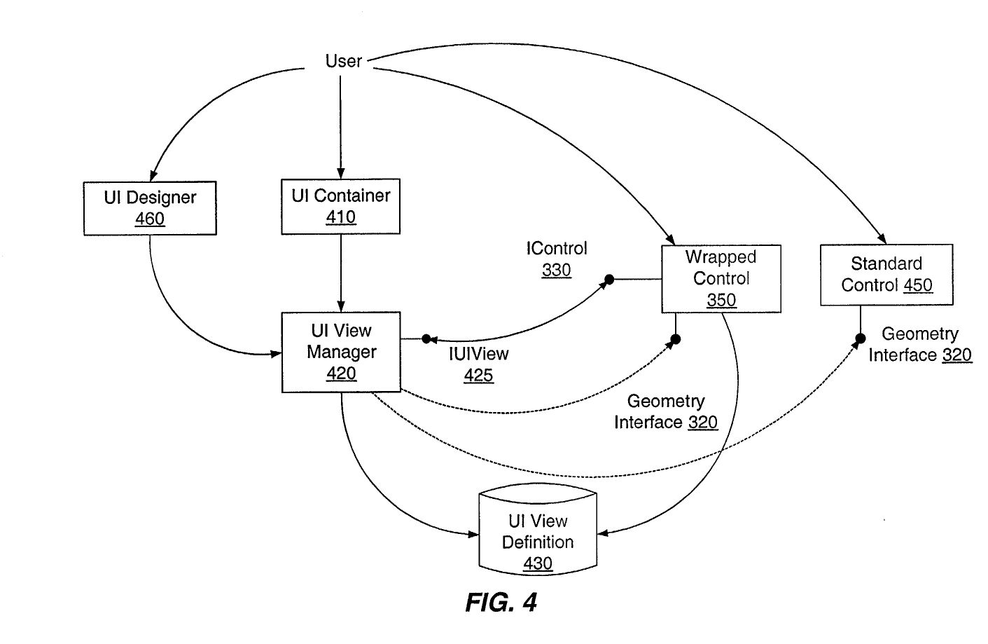

FIG. 3B shows elements of a wrapped control. A control 104 may be enclosed in a wrapper 340 that provides an implementation of a dynamic communication interface labeled IControl interface 330. The code for control 104 is embedded within the code for wrapper 340 to form wrapped control 350. Wrapper 340 enables control 104 embedded therein to dynamically be included as part of dynamic user interface 100. Wrapper 340 is discussed further below with reference to FIG. 4.

One embodiment of dynamic user interface 100 is implemented in an object-oriented programming environment, although an object-oriented implementation is not required to practice the invention. For those unfamiliar with object-oriented programming, a brief summary is presented here.

The building block of object-oriented programming is the object. An object is defined through its state and behavior. The state of an object is set forth via attributes of the object. which are included as data fields in the object. The behavior of the object is set forth by methods of the object.

Each object is an instance of a class, which provides a template for the object. A class defines zero or more data fields to store attributes of an object and zero or more methods. Attributes stored in the data fields of the object may be interpreted only using the methods specified by the object's class. Instances of panel 102 and instances of control 104 correspond to objects in an object-oriented implementation of dynamic user interface 100.

Each data field contains attribute information defining a portion of the state of an object. Objects that are instances of the same class have the same data fields, but the particular attribute values contained within the data fields may vary from object to object. Each data field may contain information that is direct, such as an integer value, or indirect, such as a reference or pointer to another object.

A method is a collection of computer instructions that execute in a processor. The methods for a particular object define the behavior of the object. The instructions of a method are executed when the method is invoked by another object or by an application program. The object performing the method is the responder, also called a responding object.

To perform the method, the name of the method is identified in the object's class to determine how to define that operation on the given object. When performing the method, the responder consumes zero or more arguments, i.e., input data, and produces zero or one result, i.e., an object returned as output data.

A class has a position in a “class hierarchy.” Methods or code in one class may be passed down the hierarchy to a subclass or inherited from a superclass, a concept called “inheritance.” When a method of an object is called, the method that is used may be defined in a class of which the object is a member or in any one of superclasses of the class of which the object is a member.

In a object-oriented component architecture, components provide building blocks of programming code. Examples of component include panel 102 and control 104. The programming code for a component may be run by a container, which is an application program or subsystem. An example of a container is Microsoft Internet Explorer within which web page components are presented. The container may be said to host the component.

FIG. 4 shows components of dynamic user interface 100. UI container 410 is an example of a container as described above and, in one embodiment, is the application program providing the environment for user interface 100. UI container 410 provides the environment in which the functionality of instances of panel 102 and control 104 operate. Preferably, UI container 410 is designed to implement only minimal functionality that is necessary to enable the instances of panel 102 and control 104 to operate. The functionality of user interface 100 is provided by the instances of control 104 that are included therein. An instance of control 104 that retrieves enterprise data when initialized retrieves the data in UI container 410.

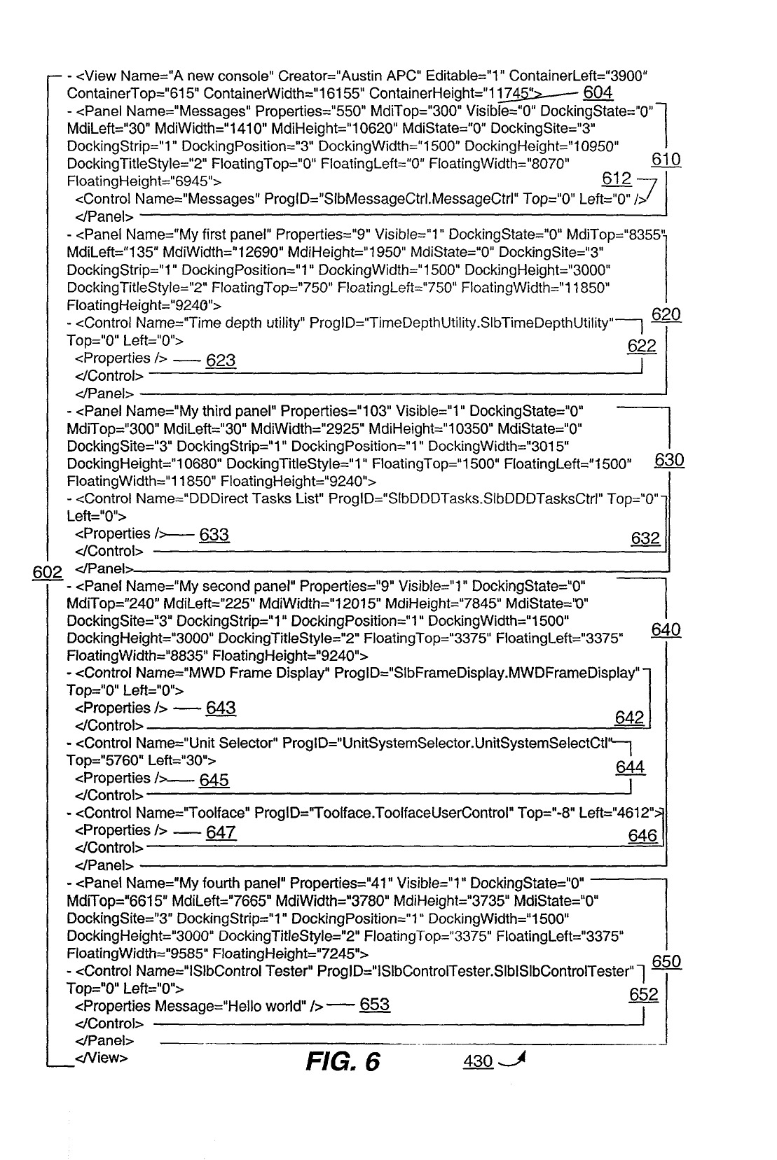

UI container 410 may obtain user interface (UI) view definitions, such as UI view definition 430. Each UI view definition 430 corresponds to a UI view, which corresponds to dynamic user interface 100. In one embodiment of the invention, a user may save one or more UI views for a particular software application to be selected from when the user is using that software application. UI container 110 may dynamically create and initialize each panel 102 and control 104 defined in the UI view definition 430 for the UI view presented to the user. An example of UI definition 430 is shown and discussed further with reference to FIG. 6.

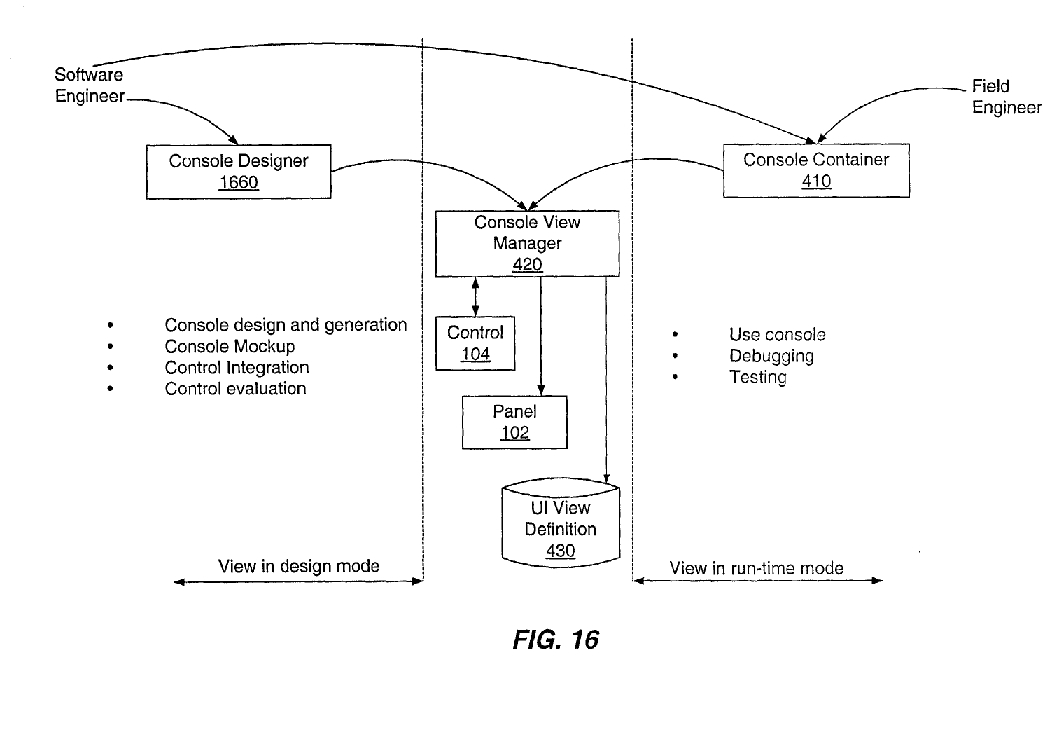

UI view definition 430 may contain the definition of each panel 102 in a particular console view, as well as properties of the panel. UI view definition may also include a description of instances of control 104 that each instance of panel 102 contains (e.g., name and geometry for each instance of control 104). While not required for dynamic user interface 100 to operate, UI designer 460 is a software tool that helps software engineers build UI view definition 430 for a UI view. UI view definition 430 and UI designer 460 are discussed further with reference to FIG. 16.

The term “standard control” is used herein to distinguish a control that is not embedded in wrapper 340 from a wrapped control. Standard control 450 is a standard control, in contrast to wrapped control 350. The term “control 104” is used herein to include both standard controls and wrapped controls.

A wrapper such as wrapper 340 may be used to enable a third-party control to communicate with UI view manager 420, which may communicate with UI container 410. For example, a third-party control may provide a graphic presentation suitable for a particular UI view. When wrapped, the third-party control may be used, for example, to display particular enterprise data in response to a request from UI view manager 420.

UI view manager 420 manages the layout of each instance of panel 102 and instance of control 104 defined in UI view definition 430 for user interface 100. UI view manager 420 sends messages to instances of control 104, where messages may include alarms, notifications, and/or text messages. UI view manager 420 may also receive messages from an instance of control 104. Instances of control 104 and UI view manager 420 may communicate with each other using interfaces IUIView interface 425 and IControl interface 330.

IUIView interface 425 is an interface that may be implemented by UI view manager 420 and used by UI container 410 to manage panels and controls. An instance of control 104 uses IUIView interface 425 to communicate with UI view manager 420, for example, to send messages. IUIView interface 425 is used by control 104 to send notifications (such as “data acquisition has stopped”) and requests (such as “show control A”) to UI view manager 420.

IUIView interface 425 may include functionality to manipulate dynamically components of user interface 100, such as adding a new instance of control 104, adding a new instance of panel 102, removing an instance of control 104, and removing an instance of panel 102. IUIView interface 425 may also include functionality to send messages, including alarms, notifications, and text messages, to an instance of control 104 and to respond to a message received from a control instance. Further, IUIView interface 425 may include functionality to determine the last instance of panel 102 to be modified and the last instance of control 104 to be modified.

IUIView interface 425 may also include functionality to register and remove registration of an instance of a control 104 with UI view manager 420 as well as to return a pointer to a registered instance of control 104 given its panel 102 name. IUIView interface 425 may include functionality to access enterprise data, to obtain UI access information such as a user login name, session name, a particular UI access field, to determine a mode (for example, run-time mode) for a view, and retrieve properties of a view. In addition, IUIView interface 425 may include functionality to show or hide a given instance of panel 102, display text messages in a status messages instance of panel 102, and set the focus to a given instance of control 104 on a given instance of panel 102.

Appendix A below is an example of one embodiment of an IUIView interface 425.

IControl interface 330 is the interface that an instance of control 104 may implement to receive notifications from UI view manager 420 and to obtain information about the UI view currently active, such as the UI name and the list of controls available for that UI view. An instance of control 104 that implements the IControl interface 330 corresponds to wrapped control 350. Wrapped control 350 includes wrapper 340, which provides code implementing the IControl interface 330, and code for an instance of control 104 embedded within wrapper 340.

IControl interface 330 may include functionality to obtain a pointer to UI view manager 420. The pointer may be used to register with UI view manager 420 to receive events and notifications provided by UI view manager 420 and to obtain UI access information provided by UI view manager 420. IControl interface 330 may include functionality for an instance of control 104 to obtain its program ID (PROGID, which is usually assigned by the native development environent of the control when the instance of control 104 is created), name, and license key if the instance of control 104 has a license key. IControl interface 330 may also include functionality to initialize an instance of control 104, such as initializing the instance with enterprise data, and to terminate an instance of control 104. IControl interface 330 may also include functionality to read internal data from UI view definition 430 and save internal data to UI view definition 430.

Appendix B below is an example of one embodiment of an IControl interface 330.

UI view manager 420 is preferably implemented so that no knowledge of the behavior of instances of control 104 is necessary to manage the instances of control 104. When necessary, UI view manager 420 can query an instance of control 104 for the IControl interface 330. If the instance of control 104 responds to the query, then UI view manager 420 can communicate with the control instance. For example, UI view manager 420 can call an initialization method of IControl interface 330 for the control to initialize itself to provide functionality. If the instance of control 104 does not respond to the query, the instance cannot communicate with UI view manager 420. After creating the instance, UI view manager 420 has no further control of the behavior of the instance.

Standard control 450, because it does not implement IControl interface 330, does not receive notifications from UI view manager 420 and cannot communicate with other instances of control 104, UI view manager 420 or UI container 410. An example of standard control 450 is the standard Microsoft Calendar control which is installed and available as freeware, with no licensing requirements, on any machine running the Microsoft Windows operating system. The Microsoft Calendar control includes functionality to provide the current date but has no capability to communicate with other instances of control 104 or to access enterprise data.

Without wrapper 340, the Microsoft Calendar control is unable to react to alarms or messages sent to the user interface 100 by UI view manager 420 because it was not programmed to participate in such communication. Although UI view manager 420 may broadcast a message to every instance of control 104, standard control 450 is unable to receive or respond to the message. Furthermore, standard control 450 is unable to access or provide enterprise data.

The dotted arrows from UI view manager 420 to geometry interface 320 of wrapped control 350 and to standard control 450 indicates that geometric functions such as resizing and moving control 104 are provided by implementing geometry interface 320. An implementation of geometry interface 320 is typically provided by the development environment in which an instance of control 104 is created and is available to every control 104 created in the development environment.

In one embodiment, each control 104 is implemented as an ActiveX component using Microsoft's ActiveX technology, although other technologies that support the concepts of controls and interfaces are suitable for implementing the invention. In the embodiment implemented using ActiveX, a control 104 may be a separate ActiveX control that is not embedded in UI container 410. IControl interface 330 and IUIView interface 425 together enable an ActiveX control to exist separately and be added dynamically to user interface 100.

Each user interface 100 may include an instance of control 104 that sets up access to enterprise data or other information used by user interface 100. Access to enterprise data may be provided by a set of objects acting as interfaces to enterprise data objects, also referred to as business objects. For example, wrapped control 350 may have access to enterprise data via the IUIView interface 425 implemented as part of UI view manager 420.

Alternatively, access to enterprise data may be provided as part of the implementation of a particular instance of a control 104 or as part of the implementation of UI container 410. Preferably, very little functionality is included as part of the implementation of UI container 410 and functionality is instead delegated to the control instance implementations.

By providing each control 104 as a separate component, a new instance of control 104 may be unit-tested as part of the user interface 100 without the need to integrate a complete set of every instance of control 104 that the user interface will ultimately include. By removing functionality of the controls from UI container 410, the functionality of each instance of control 104 may be independently tested. Using the IUIView interface 425, an instance of control 104 may be further tested in the enterprise data environment.

The relationship between control 104 and UI view manager 420 follows an observer pattern, which is a design pattern known in the object-oriented programming art. See “Design Patterns: Elements of Reusable Object-Oriented Software”, Erich Gamma, Richard Helm, Ralph Johnson, John Vlissides, Addison-Wesley Professional Computing Series (1995), pp. 293-303.

An observer pattern involves a subject and observers of the subject. UI view manager 420 serves as the subject. Observers include instances of control 104 that implement the IControl interface 330, such as wrapped control 350.

UI view manager 420 may be implemented to notify every wrapped control 350 whenever the UI view manager determines that information, such as a message, should be sent to at least one instance of control 104. UI view manager may be implemented to provide complete information to every wrapped control 350, or to provide only a notification that data is available. In response to receiving such a notification that data is available, wrapped control 350 needing the data may query UI view manager 420 to obtain complete information. UI view manager 420 may be implemented to not provide messages or notifications to controls that are not wrapped, such as standard control 450, because a control without wrapper 340 is unable to receive messages.

Wrapped controls such as wrapped control 350 may register to UI view manager 420 using the IUIView interface 330. Upon significant internal events, UI view manager 420 may invoke particular methods to communicate with every registered wrapped control 350. For example, messages may be sent to every wrapped control 350 upon the occurrence of an event.

Multiple development licenses are not required for user interface developers that are not directly involved with developing a particular control 104. In the embodiment described herein, code for control 104 is not embedded in the UI container 410 or in the UI designer 460. Therefore, while each computer system running UI container 410 or UI designer 460 will require a run-time license for each instance of a control 104, including both wrapped and standard controls, each computer system does not require development licenses for every wrapped control 350 in every UI view.

Only the developer providing wrapper 340 to construct wrapped control 350 to be included in a UI view needs a development license for the control's development environment. The license key of the native development environment of the control is used to wrap an instance of control 104 to form wrapped control 350. At that time, a wrapper license key for wrapped control 350 is generated. Other computer systems must have the wrapper license key to be able to use wrapped control 350, but do not need a developer's license key for the native development environment in which the control instance embedded in wrapped control 350 originated.

Therefore, multiple software engineers may develop different components of the user interface without needing development licenses for every control that is capable of being loaded by the user interface. Development licenses are much more expensive than the run-time licenses required to run an instance of control 104, so that licensing costs may be significantly reduced for enterprises with large software development teams.

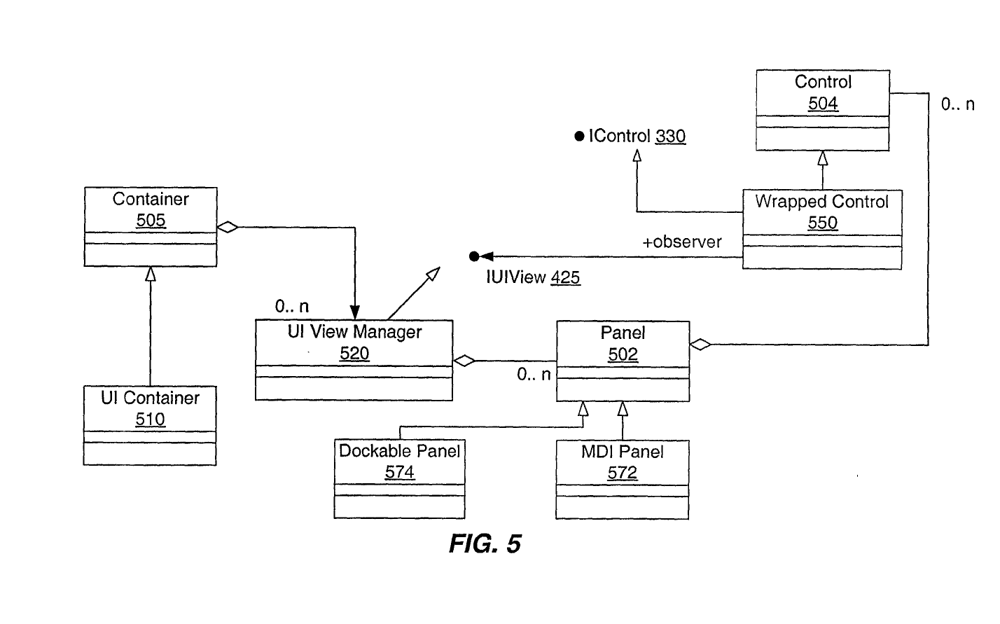

FIG. 5 shows an analysis model class diagram illustrating the key abstractions for the dynamic user interface. Container class 505 represents an abstract class for the container that provides an environment in which user interface 100 is presented. As an abstract class, container class 505 is not instantiated but provides the functionality to embed controls to instances of a subclass of container class 505. UI container class 510 corresponds to a subclass of container class 505. An instance of UI container class 510, such as UI container 410, inherits from container class 505 the basic functionality to embed controls. UI container class 510 provides extended functionality for a particular UI view. For example, UI container class 510 provides the ability to display menus as well as dockable and floatable windows.

Visually, an instance of UI container class 510 corresponds to a top-level window of user interface 100. Instances of panel 102 have a visual representation in user interface 100 within the top-level window. For example, when UI view definition 430 is read by UI container 410, particular instances of panel 102 and control 104 are instantiated by UI container 410.

UI view manager class 520 is a class defining a UI view manager. An instance of UI view manager class 520 corresponds to UI view manager 420. In the embodiment described herein, only one instance of UI view manager class 520 corresponds to a UI view, although multiple instances of UI view manager class 520 may correspond to an instance of UI container class 510. In some embodiments, UI view manager 420 may be capable of providing more than one UI view.

UI view manager 420 runs within an instance of UI container class 510 (UI container 410). An instance of UI view manager class 520 implements the IUIView interface 425. An instance of UI view manager class 520 can contain zero or more instances of panel 102; i.e., each user interface 100 can include zero or more panels. Each instance of panel class 502 similarly can contain zero or more instances of control class 504; i.e., each panel can include zero or more controls.

Panel class 502 corresponds to panel 102. The terms “an instance of panel class 502” and “an instance of panel 102” are used interchangably herein. An instance of panel 102 runs as part of UI view manager 420. An instance of panel 102 is a process started by UI view manager 420 and UI view manager 420 manages the lifetime of the panel process. Dynamic user interface 100 may provide default panels for messages and alarms.

The class diagram shows that a panel may be one of at least two types, an MDI panel and a dockable panel. MDI panel class 572 and dockable panel class 574 are subclasses of panel class 502. An instance of MDI panel class 572 corresponds to an MDI panel, which is a user interface window floating within the user interface 100 window. An instance of dockable panel class 574 corresponds to a dockable panel, also referred to as a dockable window. A dockable panel may be undocked and may float outside the boundaries provided by the top-level window for the UI view.

Control class 504 represents control 104. The terms “an instance of control class 504” and “an instance of control 104” are used interchangeably herein. An instance of control class 504 runs as part of an instance of panel 102; that is, a panel instance starts a process that corresponds to a control instance. An instance of control 104 may be a wrapped control or a standard control (a control without a wrapper). An instance of wrapped control class 550 implements IControl interface 330. An instance of wrapped control class 550 corresponds to an observer of UI view manager that receives notifications from UI view manager 420.

FIG. 6 is an example of UI view definition 430 as embodied in an XML file or in Extensible Markup Language (XML) format. However, the scope of the invention includes UI view definitions having any format from which data fields and data field values can be determined. XML is a subset of the Structured Graphics Markup Language (SGML). XML provides a uniform method for describing and exchanging structured data in an open text based format. In XML, a data field and its value are identified using tags. For example, the following XML code

<name>Joe</name>

is interpreted as meaning that the data field “name,” identified by start tag <name> and end tag <\name>, has a value of “Joe”. While the term “tag” is used to describe collectively both the start tag and the end tag, the tag is often referred to using only the start tag. For example, the tag <name><\name> is referred to herein as the <name> tag. Data associated with a tag is the data between the start tag and the end tag; in the foregoing example, the data associated with the <name> tag is Joe.

An example of a compound tag is shown below:

<name><first name>Joe</first name><last name>Smith</last name></name>

This compound tag indicates that the name is composed of a first name, “Joe”, and a last name, “Smith”.

XML files can be used to deliver data by use of the standard HTTP protocol. XML is increasingly being used to exchange data, as well as documents.

Referring to FIG. 6, view definition 602 is a definition for the UI view shown in FIG. 2. Panel definition 610 corresponds to a non-visible panel, as indicated by data field 604 indicating Visible=“0”. Panel definition 620 corresponds to panel instance 102(2-2) of FIG. 2, panel definition 630 corresponds to panel instance 102(2-1), panel definition 640 corresponds to panel instance 102(2-3), and panel definition 650 corresponds to panel instance 102(2-4).

Within panel definition 610, one control definition 612 is provided. Within panel definition 620, one control definition 622 is provided. Control definition 622 corresponds to control instance 104(2-2). This control has no internal properties, as shown by the control properties definition 623. Within panel definition 630, control definition 632 corresponds to the tree control instance 104(2-1). This control has no internal properties, as shown by control properties definition 633. Within panel definition 640, control definition 642 corresponds to control 104(2-3), control definition 644 corresponds to control 104(2-4), and control definition 646 corresponds to control 104(2-5). None of these controls have any properties, as shown by respective control properties definitions 643, 645, and 647.

Within panel definition 650, control definition 652 is provided. This control has an internal property, as shown in control properties definition 653. The control property has a message with a value of “Hello world,” shown in FIG. 2 as message 204 within control instance 104(2-6). The non-visible control defined in control definition 612 provides the text message such as message 204, here “Hello world,” to UI view manager 420. UI view manager 420 displays the text message defined in control properties definition 653 within an edit box included in the visual representation of control instance 102(2-6).

Returning to FIG. 3b, the wrapped control 350 has certain advanced characteristics. These advanced characteristics provide the dynamic functionality of a user interface 100. In one embodiment the advanced characteristics of a wrapped control 350 is achieved by implementing a specified interface, the Icontrol interface 330.

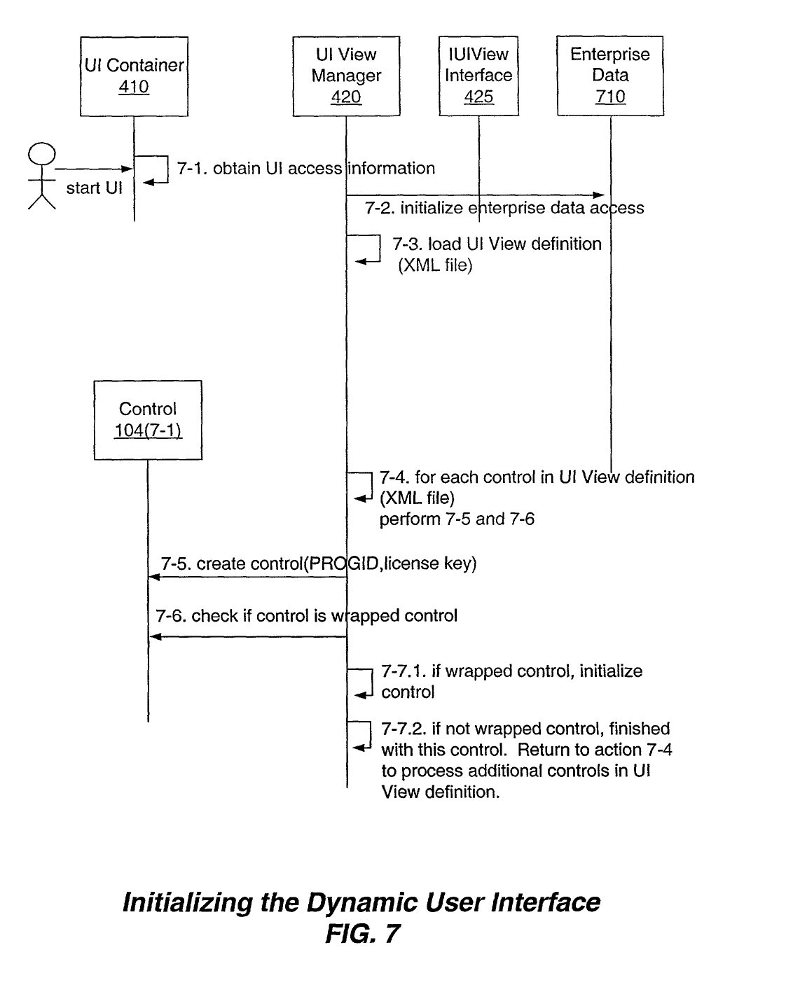

FIG. 7 is a sequence diagram showing initialization of dynamic user interface 100. When a user invokes user interface 100, for example by clicking on an icon, UI container 410 starts in run-time mode. In action 7-1, UI container 410 obtains UI access information from the user; for example, an implementation of user interface 100 may require a user to provide a login name or other identifying information. In action 7-2, UI view manager 420 uses the UI access information obtained by UI container 410 to initialize the UI container 410 environment for running the user interface 100 specified. For example, UI view manager 420 may perform initialization for access to enterprise data 710, as shown in the example, by establishing connections to enterprise databases. Other actions may be taken by UI view manager 420 in addition to, or instead of, initializing enterprise data access.

In action 7-3, UI view manager 420 loads UI view definition 430 for the user interface 100 specified by the user. In step 7-4, UI view manager 420 begins processing each control 104 defined in UI view definition 430. In step 7-5, an instance of control 104 is created, control instance 104(7-1). UI view manager 420 provides a PROGID and license key for control instance 104(7-1). The PROGID and license key are obtained from the control definition, such as control definition 650, within UI view definition 430, as described above with reference to FIG. 6.

In action 7-6, UI view manager 420 checks whether control instance 104(7-1) is a wrapped control. As described above, UI view manager 420 can query an instance of control 104 to see whether the instance implements the IControl interface 330. If control instance 104(7-1) is a wrapped control, control proceeds to in action 7-7.1. In action 7-7.1, UI View manager 420 initializes control instance 104(7-1). For example, initializing the control may involve loading data to be displayed by control instance 104(7-1).

If, in action 7-7, control instance 104(7-1) is not a wrapped control, control proceeds to action 7-7.2. In action 7-7.2, UI view manager 420 is finished with control instance 104(7-1) and returns to action 7-4 to continue processing additional controls remaining in UI view definition 430.

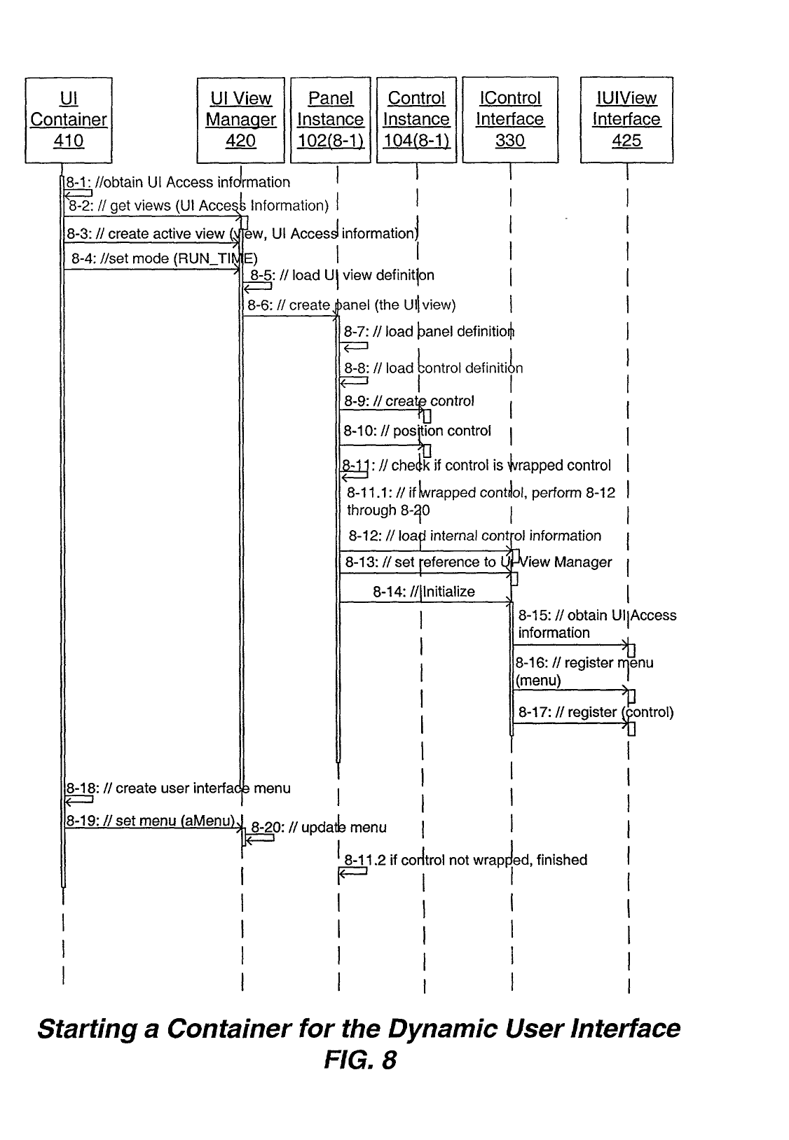

FIG. 8 is a sequence diagram showing examples of action take to start UI container 410 in run-time mode and to initialize a panel, a control, and a menu. In action 8-1, UI container 4-10 obtains UI access information as described above with reference to FIG. 7. In action 8-2, UI container 410 determines views that are available to the user. For example, UI container 410 may determine whether any UI view definitions 430 are available to the user. The UI views may be presented to the user for selection, or a UI view may be provided by the user as part of a command to start UI container 410.

In action 8-3, UI container 410 creates UI view manager 420 for the user; in other words, UI container 410 prepares to load the panels and controls as defined by UI view definition 430. The first time that UI container 410 loads a UI view definition, an “active” UI view manager 420 is “created.” Thereafter, when a user changes to a new UI view, UI view manager 420 is “refreshed” by creating new instances of panel 102, which in turn create new instances of control 104 that they embed.

In action 8-4, UI container 410 sets a mode in which the UI container 410 is used to “RUN-TIME.” Run-time mode is the standard mode of operation for user interface 100. Another mode of operation, “design mode,” for UI designer 460 is discussed below with reference to FIG. 16.

In action 8-5, UI view manager 420 loads UI view definition 430 corresponding to the active UI view. In action 8-6, an instance of panel 102 is created, panel instance 102(8-1), to provide the top-level window for user interface 100. In action 8-7, the panel instance 102(8-1) loads a panel definition, such as panel definition 650 of FIG. 6, from UI view definition 430. In action 8-8, panel instance 102(8-1) loads a control definition, such as control definition 652, from UI view definition 430. In action 8-9, an instance of the control defined in the control definition is created, control instance 104(8-1). In effect, panel instance 102(8-1) starts a sub-process for control instance 104(8-1) and controls the lifetime of the sub-process. In action 8-10, the visual representation of control instance 104(8-1) is positioned within panel instance 102(8-1).

In action 8-11, panel instance 102(8-1) determines whether the control instance 104(8-1) is a wrapped control. In action 8-11.1, if control instance 104(8-1) is a wrapped control, panel instance 102(8-1) performs actions 8-12 through 8-20. If in action 8-11, control instance 104(8-1) is not a wrapped control, control proceeds to action 8-11.2, where panel instance 102(8-1) has completed initialization of user interface 100.

In action 8-12, control instance 104(8-1) has been determined to be a wrapped control. Control instance 104(8-1) loads internal control information, if any. For example, an instance of control 104 created using control definition 652 of FIG. 6 may load control properties 653 from UI view definition 430 so that the text message can be displayed.

In action 8-13, a reference to UI view manager 420 is set by panel instance 102(8-1) by calling a method of IControl interface 330. Control instance 104(8-1) may use this reference to UI view manager 420 whenever control instance 104(8-1) needs to communicate with UI view manager 420. In action 14, control instance 104(8-1) is initialized when panel instance 102(8-1) calls an initialize method of IControl interface 330.

Actions 8-15 through 8-18 are examples of actions taken to initialize control instance 104(8-1); depending upon enterprise and system requirements, a control instance may be initialized using other, different types of actions. In action 8-15, UI access information is obtained for initializing the control. For example, login information and session name for the user may be obtained, and/or access to business objects to access enterprise data may be established. UI container 410 can provide a menu of standard options for controls. A control 104 optionally may provide menu options that can be added to the menu; in action 8-18, control instance 104(8-1) registers menu options with UI view manager 420. In action 8-19, control instance 104(8-1) registers as an observer with UI view manager 420 by calling a register method of IUIView interface 425. Registration ensure that control instance 104(8-1) receives notifications from UI view manager 420.

In action 8-20, the menu for user interface 100 is created by the UI container 410. In action 8-21, a reference to the menu is set by the UI container 410 and provided to UI view manager 420. In action 22, the menu is updated by UI view manager 420 to include the menu options for control instance 104(8-1). Only registered controls are added to the menu of available controls. Standard windows options, such as tile and cascade, are provided as menu options.

When the user activates functionality provided by a control instance on the user interface 100, UI container 410 is not involved in providing that functionality. The control instance may use the UI container 410 to display information resulting from some functionality, such as in a global list of status messages, or when the control instance needs to send an alarm to the user.

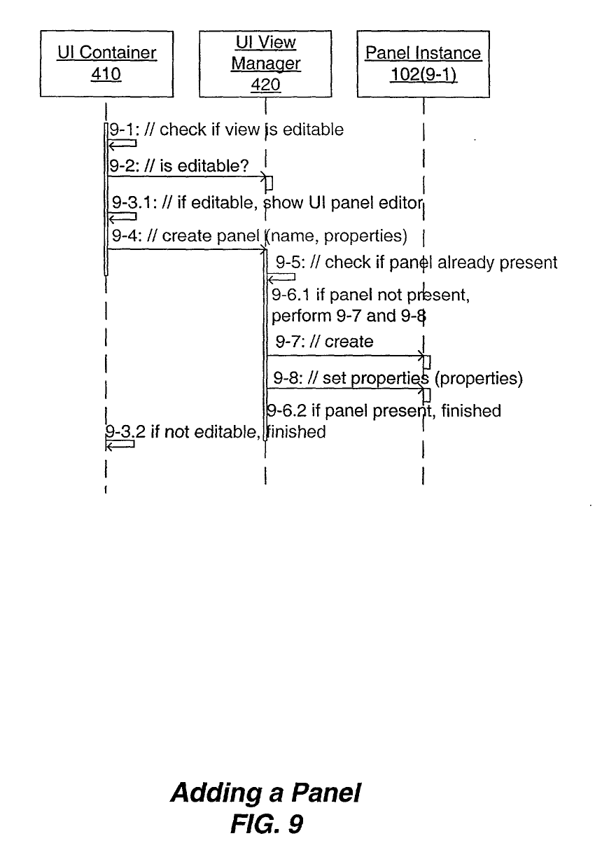

FIG. 9 is a sequence diagram showing adding a new instance of panel 102, panel instance 102(9-1), to a view. In action 9-1, UI container 410 checks whether the view has a property indicating that the view is editable. In action 9-2, UI container 410 provides the information about whether the panel is editable to UI view manager 420.

If the view is editable, in action 9-3.1 UI view manager 420 uses UI container 410 to show a UI panel editor to enable the user to edit the panel. If the view is not editable, control proceeds to action 9-3.2, which shows that UI container 410 is finished because no panel can be added to the UI view.

In action 9-4, UI container 410 requests UI view manager 420 to create an instance of panel 102, providing a panel name and properties of the panel to be created. In action 9-5, UI view manager 420 checks whether the panel is already present in the UI view. If the panel is not already present, UI view manager 420 creates panel instance 102(9-1) in action 9-6 and sets properties of panel instance 102(9-1) in action 9-7. If in step 9-5, the panel was already present, control proceeds to action 9-6.2, where UI view manager 420 is finished.

Removing a panel follows a similar process. The user selects the panel to remove. UI container 410 requests UI view manager 420 to remove the given panel. If the view is editable and the panel is also editable, then the panel will be completely removed from the view (as well as the controls the panel contains).

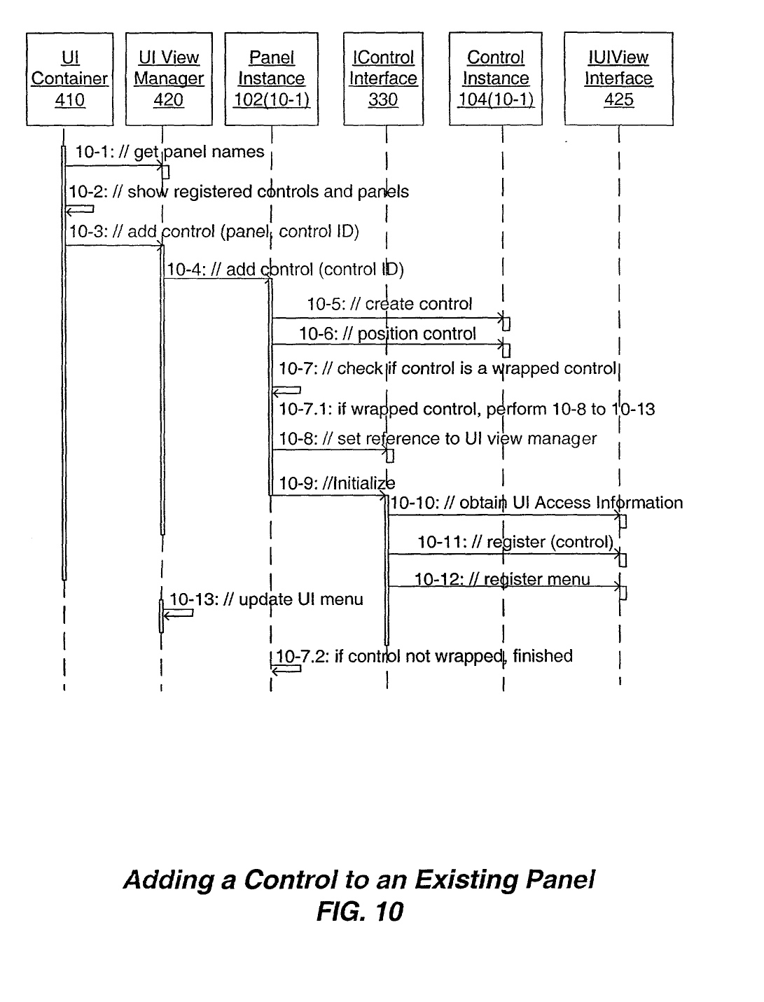

FIG. 10 is a sequence diagram showing adding a control 104 to an existing panel 102. In action 10-1, UI container 410 obtains the names of existing panels from UI view manager 420. In action 10-2, UI container 410 shows the registered controls and panels via the user interface. The user selects a panel instance 102(10-1) and a control to add to the selected panel. In action 10-3, UI container 410 requests to add the new control, providing the panel and a control ID for the new control to be added. In action 10-4, UI view manager 420 requests panel instance 102(10-1) to add the new control.

In action 10-5, panel 102 uses the IControl interface 330 to create the new control, which results in control instance 104(10-1). In action 10-6, panel instance 102(10-1) positions control instance 104(10-1) within the visual representation of the panel. In action 10-7, panel instance 102(10-1) checks whether the control instance 104(10-1) is a wrapped control by querying control instance 104(10-1). If control instance 104(10-1) is a wrapped control, panel instance 102(10-1) performs steps 10-8 through 10-13. If control instance 104(10-1) is not a wrapped control in action 10-7, control proceeds to action 10-7.2, where panel instance 102(10-1) is finished.

In action 10-8, control instance 104(10-1) has been determined to be a wrapped control. Panel instance 102(10-1) provides control instance 104(10-1) with a reference to UI view manager 420 so that control instance 104(10-1) can communicate with UI view manager 420. In action 10-9, panel instance 102(10-1) calls the initialize function of the IControl interface 330 to initialize control instance 104(10-1).

In action 10-10, control instance 104(10-1) can obtain UI access information by calling UI view manager 420 using IUIView interface 425. In action 10-11, control instance 104(10-1) can register as an observer with UI view manager 420 to receive notifications. In action 10-12, control instance 104(10-1) can register menu options with UI view manager 420.

In action 10-13, UI view manager 420 updates the menu for user interface 100 with menu options for control instance 104(10-1).

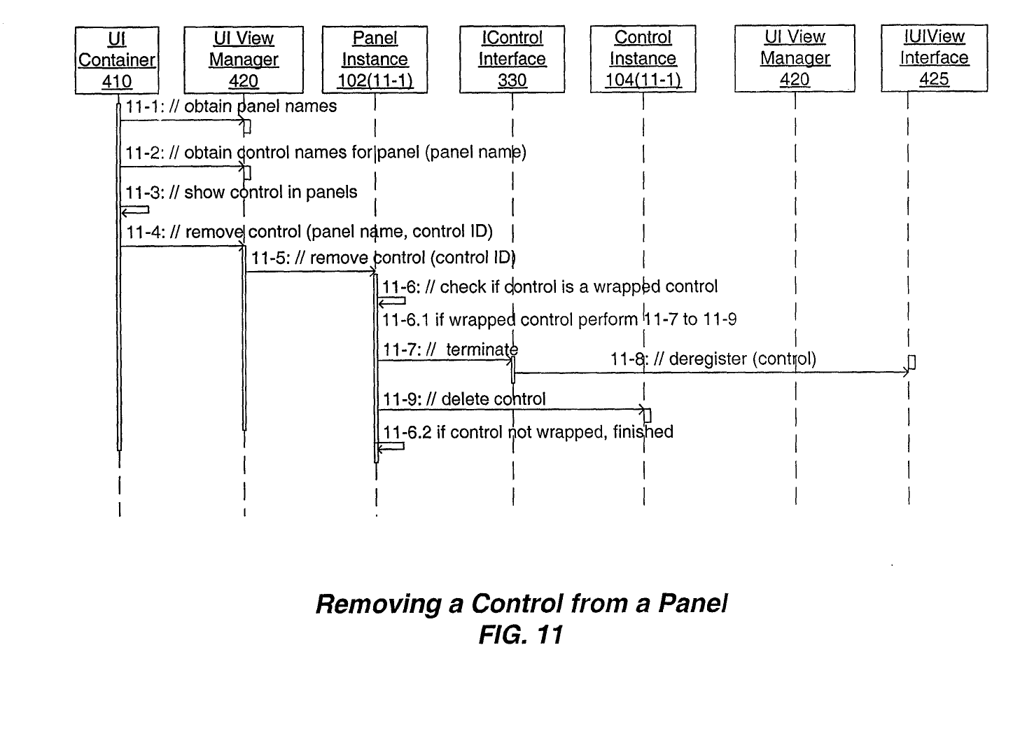

FIG. 11 is a sequence diagram showing removing an instance of a control from a panel. In action 11-1, UI container 410 obtains the names of existing panel instances of user interface 100 from UI view manager 420. The user selects a panel instance, panel instance 102(11-1), from which to remove a control. In action 11-2, UI container 410 obtains the control names of the control instances for the selected panel instance 102(11-1). In action 11-3, UI container 410 shows the controls for the selected panel via the user interface. The user selects a control instance 104(11-1) to remove. In action 11-4, UI container 410 requests UI view manager 420 to remove the selected control instance 104(11-1), providing a panel name and a control ID or control instance 104(11-1).

In action 11-5, UI view manager 420 requests panel instance 102(11-1) to remove control instance 104(11-1), providing the control ID for control instance 102(11-1). In action 11-6, panel instance 102(11-1) checks whether the control to be removed is a wrapped control. If control instance 104(11-1) is a wrapped control, control proceeds to action 11-7. If control instance 104(11-1) is not a wrapped control, control proceeds to action 11-6.2, which shows that panel instance 102(11-1) is finished.

In action 11-7, control instance 102(11-1) is terminated by panel instance 102(11-1) calling the terminate method of the IControl interface 330. This step notifies control instance 102(11-1) that it is terminated. In action 11-8, control instance 104(11-1) requests to be removed from the list of registered controls that are observers with UI view manager 420 using the IUIView interface 425. UI view manager 420 removes control instance 104(11-1) from the list of registered controls. In action 11-9, panel instance 104(11-1) deletes control instance 104(11-1).

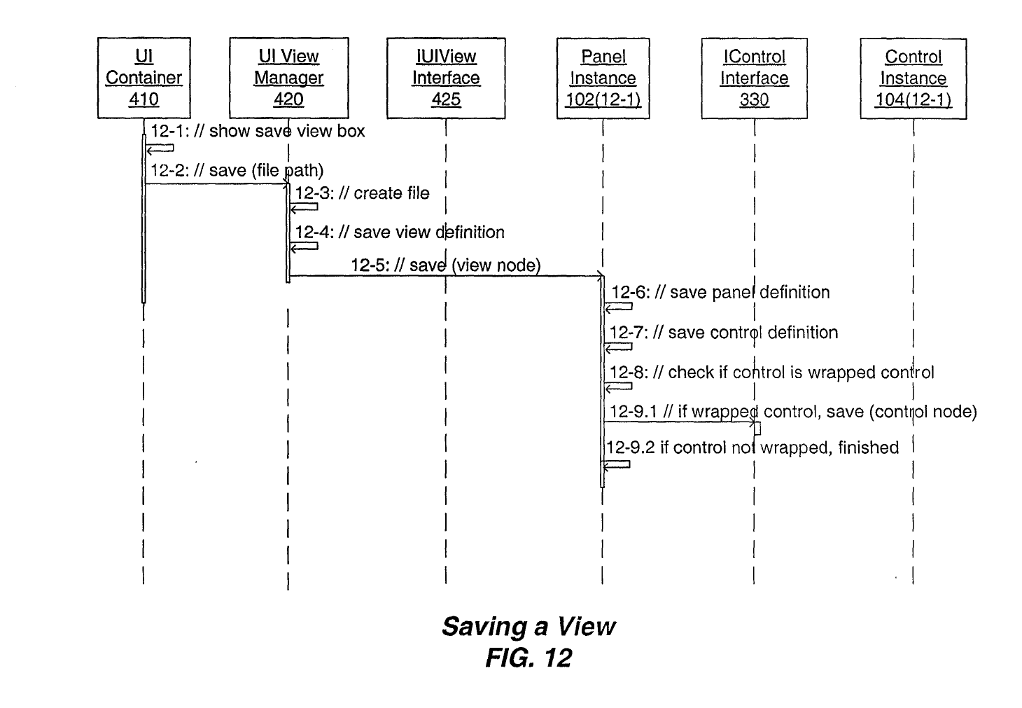

FIG. 12 is a sequence diagram showing saving a view. In action 12-1, UI container 410 shows a save view box. The user specifies a directory path in which the view is to be saved. The directory path corresponds to a file location for UI view definition 430. In action 12-2, UI container 410 provides the path to UI view manager 420. In action 12-3, UI view manager 420 creates a file and in action 12-4, UI view manager 420 saves the view definition in the file. In action 12-5, UI view manager 420 requests panel instance 102(12-1) to save its corresponding panel definition and provides a node of UI view definition 430 in which the panel definition is to be saved.

In action 12-6, panel instance 102(12-1) saves its corresponding panel definition and in action 12-7 it saves the control definition for control instance 104(12-1). In action 12-8, panel instance 102(12-1) checks whether control instance 104(12-1) is a wrapped control. If control instance 104(12-1) is a wrapped control, in action 12-9.1, panel instance 102(12-1) calls a save view method of the IControl interface 330 to save the control definition, providing a node of UI view definition 430 in which the control definition is to be saved. For example, internal control information that is not publicly accessible to UI view manager 420 or to panel instance 102(12-1) is saved by control instance 104(12-1) itself. If control instance 104(12-1) is not a wrapped control, control proceeds to action 12-9.2, where panel instance 102(12-1) is finished.

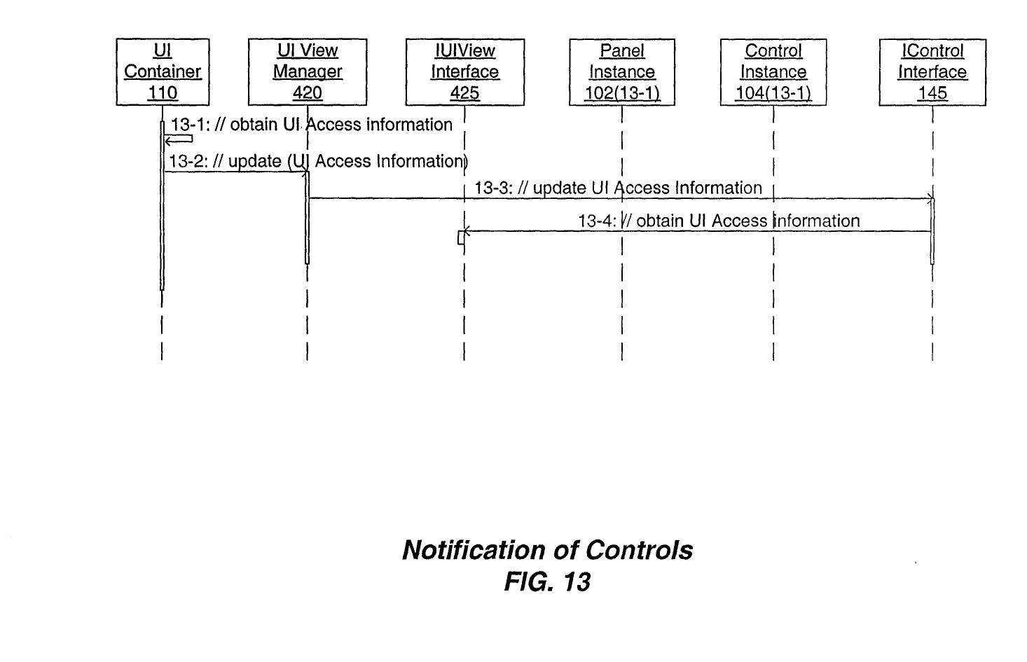

FIG. 13 is a sequence diagram showing the UI view manager 420 notifying the control 104 that UI access information has changed. For example, a user may choose to switch to another UI view or may add a new control or panel that requires different enterprise data.

As stated previously, wrapped controls act as observers of the UI view manager 420. Using this observer pattern, the UI view manager 420 may send messages (notifications) to registered controls. In action 13-1, UI container 410 obtains UI access information from the user. The user provides the UI access information. In action 13-2, UI container 410 provides UI view manager 420 with the UI access information. In action 13-3, UI view manager 420 uses panel instance 102(13-1), which uses the IControl interface 330 to notify registered control instances of the updated UI access information. Upon reception of the notification, control instance 104(13-1) may get the new UI access information from UI view manager 420 via the IUIView interface 425.

In the embodiment shown in this example, updated UI access information is not broadcast to all control instances, as not all control instances may need or use UI access information. In large systems, this saves system resources and communication bandwidth, as only those controls needing the information can request to receive the updated data. Other embodiments may broadcast complete data to all controls and leave it up to the controls to determine whether to use the information.

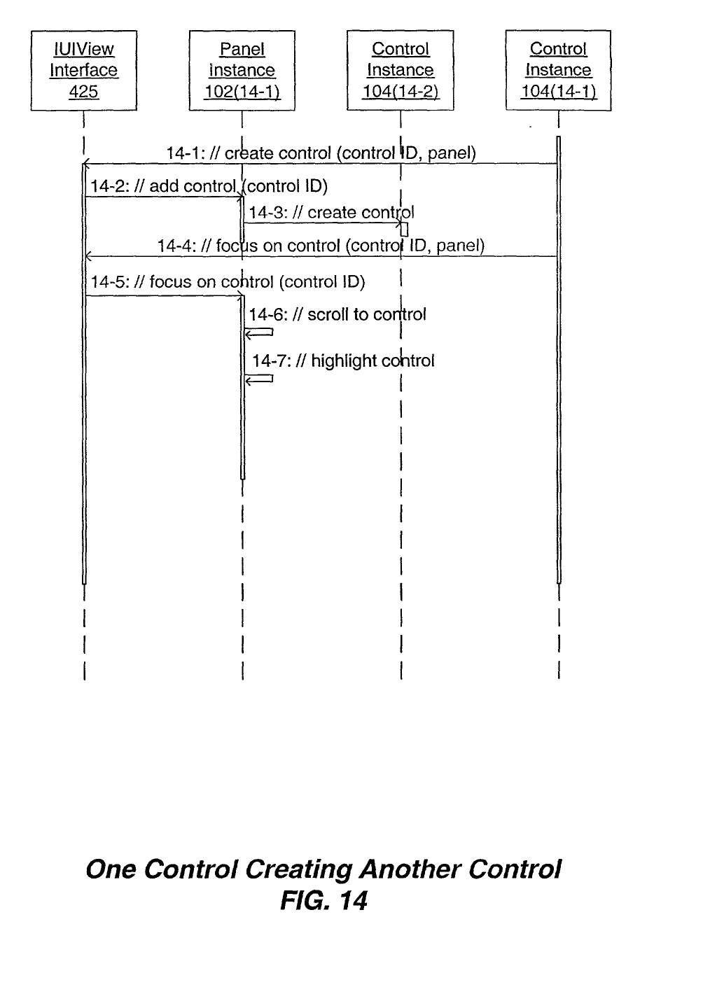

FIG. 14 is a sequence diagram showing one control instance creating another control instance. The IUIView interface 425 provides methods that controls may use to “communicate” with other controls. In action 14-1, control instance 104(14-1) uses the create control method of the IUIView interface 425 to add a control 104 to an existing panel instance 102(14-1). In action 14-2, the control ID for the new control instance is passed to panel instance 102(14-1), which creates control instance 104(14-2). In action 14-3. In action 4, control instance 104(1) uses the set focus method on the IUIView interface 425 to request panel instance 102(14-1) to set the focus to the newly added control instance 104(14-2). In action 14-5, panel instance 102(14-1) focuses control on control instance 104(14-2). In action 14-6, panel instance 102(14-1) scrolls to control instance 104(14-2). In action 14-7, panel instance 102(14-1) highlights control instance 104(14-2).

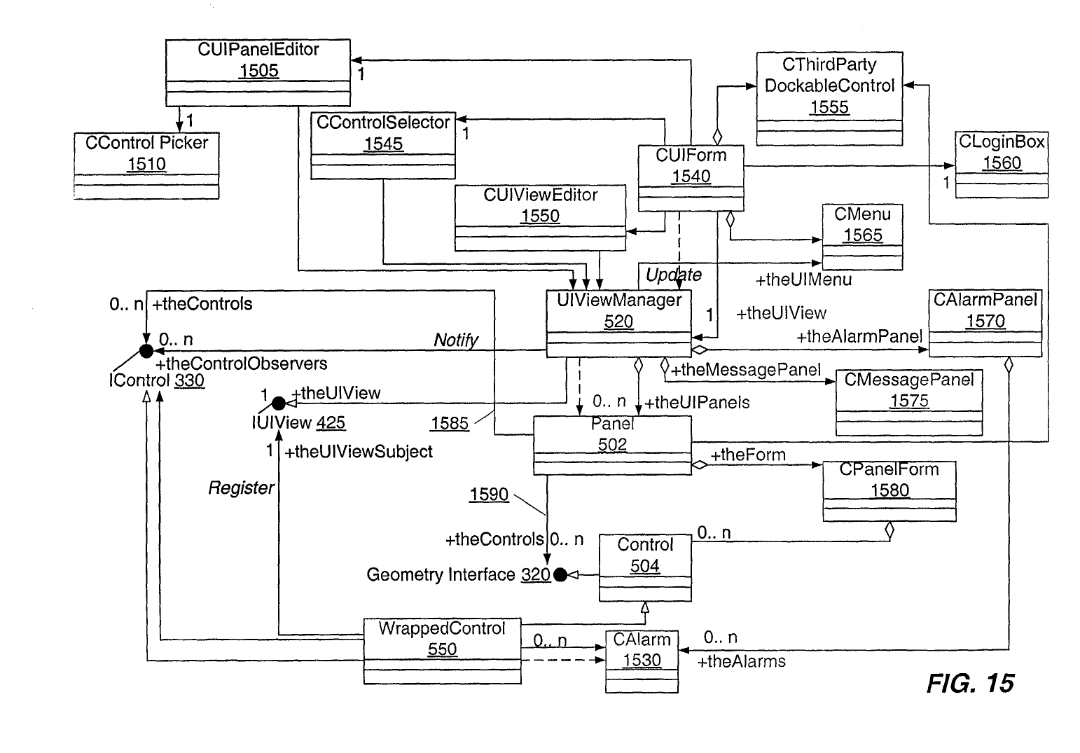

FIG. 15 is a design class diagram for an example implementation of the dynamic user interface. Examples illustrating objects of the classes are described with reference to FIG. 2. CUIForm class 1540 corresponds to the top-level window for user interface 100 (such as window 202 of FIG. 2). In this implementation, CUIForm class 1540 functionality includes the extended functionality provided by UIContainer class 510.

CUIForm class1540 contains CThirdPartyDockableControl class 1555 and CMenu class 1565. An instance of CUIform class 1540 contains an instance of CThirdPartyDockableControl class 1555 and an instance of CMenu class 1565. The top-level window for a view according to the invention, such as window 202 of FIG. 2, contains a menu such as menu 203 and a dockable panel, such as panel instance 102(2-1), each of which provides options for the user interface. Other embodiments of the invention may not provide menus or dockable controls and may provide other different controls as part of the top-level window.

CUIForm class 1540 is associated with CLoginBox class 1560, CUIViewEditor class 1550, CUIPanelEditor class 1505, and CControlSelector class 1545. UI Container 410 may obtain UI access information such as a user name via a login box provided by an object of CLoginBox class 1560. In other embodiments, a login box may not be provided. The functions of editing views, panels, and controls are respectively related to objects instantiating CUIViewEditor class 1550, CUIPanelEditor class 1505, and CControlSelector class 1545. CUIPanelEditor class 1505 further is related to CControlPicker class 1510. When a user edits a panel, a pick list of controls in the panel may be presented from which the user can select.

Each of classes CUIViewEditor class 1550, CUIPanelEditor class 1505, and CControlSelector class 1545 provide editing functionality for UI view manager 420. As described above, an instance of UIViewManager class 520 of FIG. 5 corresponds to UI view manager 420. As described above, UI view manager 420 implements the IUIView interface 425.

UIViewManager class 520 contains panel class 502 as described above with reference to FIG. 5. In the implementation shown in this diagram, panel class 502 includes functionality to recognize controls that implement IControl interface 330 (wrapped controls). An instance of panel 102 contains an instance of CPanelForm class 1580 to provide other standard panel functionality. An instance of CPanelForm class 1580 contains an instance of control class 504. An instance of control class 504 is also referred to herein as an instance of control 104.

An instance of control 104 can be a wrapped control, which is an instance of WrappedControl class 550, such as wrapped control 350. As described above, an instance of wrapped control class 550 includes a wrapper, such as wrapper 340, that implements the IControl interface 330. An instance of wrapped control class 550 can register with UI view manager 420 using the IUIView interface 425. An instance of wrapped control class 550 is an observer of UI view manager 420, which is the subject, as described above. Instances of wrapped control class 550 can send alarms, which are instances of CAlarm class 1530 that are displayed in an alarm panel, which is an instance of CAlarmPanel class 1570.

An instance of panel class 502 can communicate with embedded instances of control class 504 via geometry interface 320 and IControl interface 330. The instance of panel class 502 uses geometry interface 320, as shown in communication 1590, to resize, move and perform other functions affecting the geometry of an instance of control class 504. An instance of panel class 502 uses IControl interface 330, as shown in communication 1585, to perform functions such as creating a control instance.

To determine whether an instance of control 104 is a wrapped control, an instance of panel class 502 can query the embedded instance of CPanelForm class 1580 about the instances of control class 504 that are contained therein. The instance of panel class 502 queries each instance of control class 504 contained within the instance of CPanelForm class 1580 to determine the control instances therein that implement IControl interface 330.

The term “an instance of panel 102” as used herein includes an instance of panel 502 that contains an instance of CPanelForm class 1580 that contains the instances of control class 504. Alternative embodiments of panel class 502 are included within the scope of the invention.

As described above, special panel instances may be provided for alarms and status messages. In the embodiment shown here, a special panel for alarms is an instance of CAlarmPanel class 1570, and a special panel for status messages is an instance of CMessagePanel class 1575. A user interface pastel& an instance of panel class 502 that contains an instance of CPanelForm class 1580. Special panels may not be provided in some embodiments of the invention.

FIG. 16 presents two modes of operation for UI view manager 420, run-time mode and design mode. While not required for dynamic user interface 100 to operate, UI designer 460 is a software tool that helps software engineers build UI views, wherein a UI view corresponds to user interface 100. A UI view definition 430 may be designed in UI designer 460 and used in the UI container 410. By using UI designer 460, software engineers may easily and quickly design a user interface 100. Software engineers may also use UI designer 460 for creating quick user interface mockups, validating integration of new controls, and evaluating the look and feel of new controls.

UI designer 460 exports a user interface view to a UI view definition 430. As described above, UI view definition is used and updated by UI view manager 420 and UI container 410. UI view definition 430 may be implemented as an XML file or other file from which information about user interface components may be stored and/or obtained.

UI designer 460 uses only the user interface parts of a control 104, and hence is considered to run in design mode. For example, in design mode, instances of control 104 are not initialized to speed the design process. For example, at run time, some controls may connect to a database when being created, but in UI designer 460 running in design mode, the connection to the database is not made. Software engineers may view the visual layout of the controls quickly, aiding productivity and speed when designing a UI view.

Software engineers use UI container 410 to debug and test the functionality of instances of control 104. Field engineers use the end product user interface 100 and may participate and debugging and testing new interfaces in a rapid prototyping scenario.

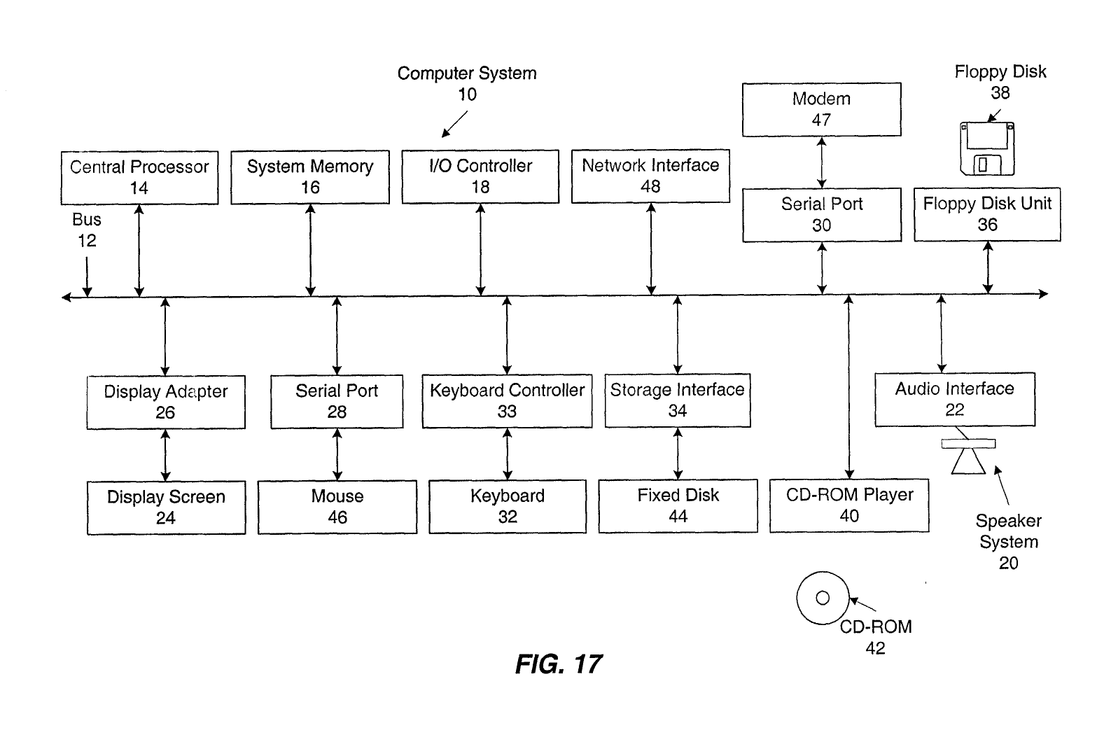

The embodiments described herein may be implemented in a computer system. A computer system of any appropriate design, in general, including a mainframe, a mini-computer or a personal computer system, may be used to practice the present invention. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of input/output (I/O) devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system is shown in detail in FIG. 17.

FIG. 17 depicts a block diagram of a computer system 10 suitable for implementing the present invention. Computer system 10 includes a bus 12 which interconnects major subsystems of computer system 10 such as a central processor 14, a system memory 16 (typically RAM, but which may also include ROM, flash RAM, or the like), an input/output controller 18, an external audio device such as a speaker system 20 via an audio output interface 22, an external device such as a display screen 24 via display adapter 26, serial ports 28 and 30, a keyboard 32 (interfaced with a keyboard controller 33), a storage interface 34, a floppy disk unit 36 operative to receive a floppy disk 38, and a CD-ROM player 40 operative to receive a CD-ROM 42. Also included, for completeness, are a mouse 46 (or other point-and-click device, coupled to bus 12 via serial port 28), a modem 47 (coupled to bus 12 via serial port 30) and a network interface 48 (coupled directly to bus 12).

Bus 12 allows data communication between central processor 14 and system memory 16, which may include both read only memory (ROM) or flash memory (neither shown), and random access memory (RAM) (not shown), as previously noted. The RAM is generally the main memory into which the operating system and application programs are loaded and typically affords at least 16 megabytes of memory space. The ROM or flash memory may contain, among other code, the Basic Input-Output system (BIOS) which controls basic hardware operation such as the interin action with peripheral components. Application programs resident with computer system 10 are generally stored on and accessed via a computer readable medium, such as a hard disk drive (e.g., fixed disk 44), an optical drive (e.g., CD-ROM player 40), floppy disk unit 36 or other storage medium. Additionally, application programs may be in the form of electronic signals modulated in accordance with the application and data communication technology when accessed via network modem 47 or interface 48.

Storage interface 34, as with the other storage interfaces of computer system 10, may connect to a standard computer readable medium for storage and/or retrieval of information, such as a fixed disk drive 44. Fixed disk drive 44 may be a part of computer system 10 or may be separate and accessed through other interface systems. Many other devices may be connected such as a mouse 46 connected to bus 12 via serial port 28, a modem 47 connected to bus 12 via serial port 30 and a network interface 48 connected directly to bus 12.

Although the examples herein are described with computer 10 in a stand-alone environment, computer 10 may be linked to a network to practice the invention. Modem 47 may provide a direct network connection to a remote server via a telephone link or to the Internet via an internet service provider (ISP). Network interface 48 may provide a direct connection to a remote server via a direct network link such as a direct link to the Internet via a POP (point of presence). Network interface 48 may provide such connection using wireless techniques, including digital cellular telephone connection, Cellular Digital Packet Data (CDPD) connection, digital satellite data connection or the like.

When computer 10 connects to the Internet, computer 10 is able to access information on one or more of servers (not shown) using, for example, a web browser (not shown). An example of the type of information accessed includes the pages of a web site hosted on one of the servers. Protocols for exchanging data via the Internet are well known to those skilled in the art. While the Internet may be used by computer 10 for exchanging data, the present invention is not limited to the Internet or to any network-based environment and, as described above, may operate in a stand-alone environment.

The web browser running on computer 10 may employ a TCP/IP connection to pass a request to one of the network servers, which may run an HTTP “service” (e.g., under the WINDOWS® operating system) or a “daemon” (e.g., under the UNIX® operating system), for example. Such a request may be processed, for example, by contacting an HTTP server employing a protocol that may be used to communicate between the HTTP server and the given client computer. The HTTP server then responds to the request, typically by sending a web page formatted as an HTML file. The web browser interprets the HTML file and may form a visual representation of the HTML file using local resources of the given client computer system, such as locally available fonts and colors.

Many other devices or subsystems (not shown) may be connected in a similar manner (e.g., bar code readers, document scanners, digital cameras and so on). Conversely, it is not necessary for all of the devices shown in FIG. 17 to be present to practice the present invention. The devices and subsystems may be interconnected in different ways from that shown in FIG. 17. The operation of a computer system such as that shown in FIG. 17 is readily known in the art and is not discussed in detail in this application. Code to implement the present invention may be stored in computer-readable storage media such as one or more of system memory 16, fixed disk 44, CD-ROM 42, or floppy disk 38. Additionally, computer system 10 may be any kind of computing device, and so includes a personal data assistants (PDA), network appliance, X-window terminal or other such computing device. The operating system provided on computer system 10 may be MS-DOS®, MS-WINDOWS®, OS/2®, UNIX®, Linux® or another known operating system. Computer system 10 also supports a number of Internet access tools, including, for example, an HTTP-compliant web browser having a JavaScript interpreter, such as Netscape Navigator®, Microsoft Explorer® and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The present invention provides many advantages. The present invention provides a user interface that may be dynamically modified by a user. The user interface is generated from a UI view definition that defines panels and controls to be included as part of the user interface. The user may modify the UI view definition and a UI view manager dynamically generates the user interface. Controls are wrapped to include a communication interface to dynamically communicate with the UI view manager.

The present invention reduces the amount of code and responsibility given to the user interface. Controls implement functionality of the user interface, hence reducing maintenance of the user interface itself. The invention greatly contributes to the reusability of code for controls.

In the design presented herein, code implementing instances of control 104 is not embedded in the UI container 410 or in the UI designer 460. Therefore, while each computer system running UI container 410 and/or UI designer 460 will require run-time licenses for each control 104, each computer system does not require an additional development license for every control 104 the user interface will ultimately support. A development license for a control's native development environment is only required for the software engineer that develops that control. Run-time licenses are generally much less expensive than development licenses.

By providing each control 104 as a separate component, a new control 104 may be unit-tested as part of the user interface without the need to integrate a complete set of every control 104 that the user interface will ultimately include. By removing functionality of the control from the UI container 410, the functionality of each control 104 may be independently tested within the enterprise data framework.

Other Embodiments

The present invention has been described in the context of software applications running on one or more computer systems. However, those skilled in the art will appreciate that the present invention is capable of being distributed as a program product in a variety of forms, and that the present invention applies equally regardless of the particular type of signal bearing media used to actually carry out the distribution. Examples of signal bearing media include: recordable media such as floppy disks and CD-ROM and transmission media such as digital and analog communication links, as well as media storage and distribution systems developed in the future.

Additionally, the foregoing detailed description has set forth various embodiments of the present invention via the use of block diagrams, flowcharts, and examples. It will be understood by those within the art that each block diagram component, flowchart step, and operation and/or element illustrated by the use of examples may be implemented, individually and/or collectively, by a wide range of hardware, software, firmware, or any combination thereof. In one embodiment, the present invention may be implemented via Application Specific Integrated Circuits (ASICs). However, those skilled in the art will recognize that the embodiments disclosed herein, in whole or in part, may be equivalently implemented in standard integrated circuits, as a computer program running on a computer, as firmware, or as virtually any combination thereof. Designing the circuitry and/or writing the programming code for the software or firmware would be well within the skill of one of ordinary skill in the art in light of this disclosure.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are exemplary only, and are not exhaustive of the scope of the invention. Consequently, the invention is intended to be limited only by the spirit and scope of the appended claims, giving full cognizance to equivalents in all respects.

[image]

[image]

[image]

[image]

[image]

[image]

[image]

[image]

[image]

[image]

[image]

What is claimed is:

1. An apparatus comprising:
a UI view definition for a user interface; and
a UI view manager operable to dynamically generate the user interface from the UI view definition, wherein the UI view manager instantiates a wrapped control as part of the user interface.

2. The apparatus of claim 1 wherein
the wrapped control comprises:
a control; and
a wrapper;
and
the UI view manager instantiates the wrapped control by providing the control as part of the user interface using the wrapper.

3. The apparatus of claim 1 wherein
the user interface comprises a plurality of controls, the wrapped control being one of the controls.

4. The apparatus of claim 1 wherein
the UI view manager is operable to dynamically add a new wrapped control to the user interface.

5. The apparatus of claim 1 wherein
the user interface includes a plurality of controls; and
the UI view manager is operable to dynamically remove an existing control of the controls from the user interface.

6. The apparatus of claim 1 wherein
the UI view manager is operable to dynamically change a function of the wrapped control.

7. The apparatus of claim 1 further comprising:
a UI container, wherein
the user interface is provided within an environment provided by the UI container.

8. The apparatus of claim 1 wherein
the UI view manager provides the wrapped control as part of the user interface by including a user interface element of the wrapped control in the user interface.

9. The apparatus of claim 1 wherein the UI view manager instantiates the wrapped control as part of the user interface by:
providing functionality of the wrapped control to be performed in response to activating a user interface element of the wrapped control in the user interface.

10. The apparatus of claim 1 wherein the wrapped control comprises:
code to implement a control interface, wherein the implementation of the control interface enables the UI view manager to invoke some behavior of the wrapped control by invoking methods of the implementation of the control interface.

11. The apparatus of claim 1 wherein
the UI view manager contains an implementation of a UI view interface and
the wrapped control invokes function of the UI view interface implementation of the UI view interface to communicate with the UI view manager.

12. The apparatus of claim 1 wherein
the UI view manager is operable to dynamically generate the user interface in response to a change to the UI view definition.

13. The apparatus of claim 1 further comprising:
a user interface designer for providing a UI view definition.

14. The apparatus of claim 1 wherein
the UI view definition corresponds to an XML file.

15. The apparatus of claim 1 wherein
the UI view definition comprises a control definition for the wrapped control, wherein the control definition specifies a user interface element of the wrapped control and a program identifier of code to provide functionality of the wrapped control.

16. The apparatus of claim 1 wherein
the UI view definition comprises a panel definition for a panel of the user interface.

17. The apparatus of claim 16 wherein
the panel definition comprises a control definition for a control to be presented in the panel, wherein the control definition specifies a user interface element of the control and a program identifier of code to provide functionality of the control.

18. A method for providing a user interface comprising:
generating a user interface from a UI view definition and dynamically editing the user interface,
wherein
the generating includes creating a wrapper for generating a wrapped control as part of the user interface.

19. The method of claim 18 further comprising:
dynamically adding a new wrapped control to the user interface.

20. The method of claim 18 further comprising:
dynamically changing a function of the wrapped control.

21. The method of claim 18 further comprising:
dynamically removing an existing wrapped control from the user interface.

22. The method of claim 18 further comprising:
sending a message to the wrapped control via a control interface associated with the wrapper.

23. The method of claim 18 further comprising:
receiving a message from the wrapped control via a UI view interface associated with a UI view manager.

24. The method of claim 18 wherein creating a wrapper comprises:
implementing at least one function of a control interface.

25. The method of claim 24 wherein the at least one function is selected from the set a first function to cause the control to read its internal data, a second function to cause the control to load a property of the control from the UI view definition, a third function to save a property of the control to the UI view definition, a fourth function to return a license key for the control, a fifth function to initialize a property of the control, and a sixth function to receive a notification about a user interface event.

26. The method of claim 18 further comprising:
generating a UI view manager by implementing at least one function of an IUI view interface the function selected from the set a first function returning a table of references to business objects, a second function returning a parameter to provide scope of access to a control of the user interface, a third function to register a control for providing alarm information to the control, a fourth function to deregister a control to terminate providing alarm information to the control, a fifth function to create a user interface panel for housing controls, a sixth function to create a user interface panel for adding a control to a user interface panel, a seventh function to remove a panel from the user interface, an eight function to remove a control from a user interface panel, a ninth function to activate or deactive a control, a tenth function to display a text message of a control on a status message panel.

27. A computer system comprising:
a processor;
a display screen, coupled to said processor;
computer readable medium coupled to said processor; and
computer code, encoded in said computer readable medium,
configured to cause said processor to dynamically generate a user interface from a UI view definition on the display screen,
by virtue of being configured to cause said processor to:
use a wrapper to generate a wrapped control as part of the user interface.

28. The computer system of claim 24 wherein
said processor is further configured to dynamically add a new wrapped control to the user interface.

29. The computer system of claim 24 wherein
said processor is further configured to dynamically change a function of the wrapped control.

30. The computer system of claim 24 wherein
said processor is further configured to dynamically remove an existing wrapped control from the user interface.

31. The computer system of claim 24 wherein
said processor is further configured to dynamically send a message to the wrapped control via a control interface associated with the wrapper.

32. The computer system of claim 24 wherein
said processor is further configured to dynamically receive a message from the wrapped control via a UI view interface associated with a UI view manager.

33. A computer program product comprising:
generating instructions to dynamically generate a user interface from a UI view definition, wherein
the generating instructions include using instructions for using a wrapper to generate a wrapped control as part of the user interface;
and
a computer-readable medium that stores the generating instructions and the using instructions.

34. The computer program product of claim 33 further comprising:
adding instructions to dynamically add a new wrapped control to the user interface;
and wherein
the computer-readable medium further stores the adding instructions.

35. The computer program product of claim 33 further comprising:
changing instructions to dynamically change a function of the wrapped control;
and wherein
the computer-readable medium further stores the changing instructions.

36. The computer program product of claim 33 further comprising:
removing instructions to dynamically remove an existing wrapped control from the user interface;
and wherein
the computer-readable medium further stores the removing instructions.

37. The computer program product of claim 33 further comprising:
sending instructions to send a message to the wrapped control via a control interface associated with the wrapper;
and wherein
the computer-readable medium further stores the sending instructions.

38. The computer program product of claim 33 further comprising:
receiving instructions to receive a message from the wrapped control via a UI view interface associated with a UI view manager;
and wherein
the computer-readable medium further stores the receiving instructions.

39. An apparatus comprising:
generating means for dynamically generating a user interface from a UI view definition,
wherein
the generating means includes using means for using a wrapper for generating a wrapped control as part of the user interface.

40. The apparatus of claim 39 further comprising:
adding means for dynamically adding a new wrapped control to the user interface.

41. The apparatus of claim 39 further comprising:
changing means for dynamically changing a function of the wrapped control.

42. The apparatus of claim 39 further comprising:
removing means for dynamically removing an existing wrapped control from the user interface.

43. The apparatus of claim 39 further comprising:
sending means for sending a message to the wrapped control via a control interface associated with the wrapper.

44. The apparatus of claim 39 further comprising:
receiving means for receiving a message from the wrapped control via a UI view interface associated with a UI view manager.

45. A system comprising:
a wrapped control; and
a UI view manager, wherein
the UI view manager dynamically provides the wrapped control as part of a user interface.

46. A system comprising:
a wrapped control comprising:
a control; and
a wrapper around the control;
and
a UI view manager, wherein
the UI view manager uses the wrapper to dynamically provide the control as part of a user interface.

47. A signal embodied in a carrier wave comprising:
generating instructions to dynamically generate a user interface from a UI view definition, wherein
the generating instructions include using instructions for using a wrapper to generate a wrapped control as part of the user interface.

48. A signal embodied in a carrier wave comprising:
a user interface 100 produced by generating instructions to dynamically generate the user interface from a UI view definition, wherein
the generating instructions include using instructions for using a wrapper to generate a wrapped control as part of the user interface.
